(19) United States
(12) Patent Application Publication
(10) Pub. No.: US 2011/0224067 A1
(43) Pub. Date: Sep. 15, 2011

(54) NOVEL ULTRA STABLE ZEOLITE Y AND METHOD FOR MANUFACTURING THE SAME

(76) Inventors: Richard Franklin Wormsbecher, Dayton, MD (US); Wu-Cheng Cheng, Ellicott City, MD (US); Michael Wallace, Glenelg, MD (US); Wilson Suarez, Sykesville, MD (US); Yuying Shu, Ellicott City, MD (US)

(21) Appl. No.: 13/130,402

(22) PCT Filed: Dec. 17, 2009
(86) PCT No.: PCT/US09/06654

§ 371 Date: May 20, 2011

Related U.S. Application Data
(60) Provisional application No. 61/203,096, filed on Dec. 18, 2008.

(51) Int. Cl. B01J 29/08; C01B 39/24

(52) U.S. Cl. 502/64; 423/700; 502/79; 502/73

(57) ABSTRACT

This invention comprises USY zeolite prepared by treating a USY zeolite under hydrothermal conditions after forming the USY zeolite from heat treating ammonium exchanged zeolite Y, e g, by calcination. When this invention is used in a FCC catalyst, a significant improvement of activity and selectivity in the fluid catalytic cracking (FCC) performance is observed, compared to FCC catalysts containing conventional USY zeolite. The process used to make the invention is efficient and comprises treating the USY zeolite in an exchange bath under the aforementioned hydrothermal conditions. The surface of the resulting USY zeolite has a molar ratio of alumina to silica that is higher than that seen in the bulk USY zeolite and has a unique structure as viewed by SEM and TEM.

### BACKGROUND OF THE INVENTION

The invention relates to ultrastable zeolite Y (USY), methods for manufacturing the same, and use of such zeolites in cracking catalysts to improve the catalyst's gasoline selectivity, and octane enhancing properties, as well as to reduce coke contamination when the catalyst is used in a fluidized catalytic cracking process. The terms “USY” and “USY zeolite” are used interchangeably herein.

Refiners are always looking for methods and catalysts to enhance the product output of their fluidized catalytic cracking (FCC) unit. Gasoline is a primary product of the FCC unit, and refiners have developed a number of catalysts to enhance yields of naphtha fractions that are later pooled and blended with other refinery streams to make gasoline. Illustrative catalysts include those containing USY zeolites and rare earth USY zeolites, also known as REUSY zeolites. Such catalysts are usually incorporated with selective matrices.

Gasoline yield and catalyst life is also influenced by the amount of carbon (coke) deposited on the catalyst during contact with the petroleum feedstock in the reactor. The refinery removes substantial amounts of coke from the catalyst by cycling catalyst from the reactor to a regenerator operated under severe hydrothermal conditions to burn off the deposited carbon. Nevertheless, some coke does remain after regeneration and collects on the surfaces and in the catalyst pores over the repeated reaction/regeneration cycles. Eventually, this residual coke buildup effectively deactivates the catalyst. It is in the interest of the refiner to reduce coke deposits and/or the formation of coke so as to lengthen the catalyst's active life, as well as insure an efficient catalytic activity during that life. Typical methods for reducing coke formation and coke deposits include making zeolites with low unit cell sizes, and/or incorporating metal passivation technologies into the catalyst formulation, e.g., additives and selective matrices that passivate or otherwise render the catalyst tolerant of metals known to increase catalyst coking.

Enhancing octane in a refiner's FCC products is another issue frequently addressed in FCC units. Octane is typically affected by hydrogen transfer reactions. Methods for addressing octane enhancement include modifying a base FCC catalyst composition for control of zeolite cell size, and/or including additives for producing olefins.

As suggested above, USY zeolites are predominantly used to crack hydrocarbons into fractions suitable for further processing into gasoline. One of the principal problems encountered in incorporating USY zeolites into fluid cracking catalyst often is lack of structural stability at high temperatures in the presence of sodium. See for example U.S. Pat. No. 3,293,192. The zeolite's structural stability is very important because the regeneration cycle of a fluid cracking catalyst requires that a catalyst be able to withstand steam and/or thermal atmospheres in the range of 1300-1700° F. Any catalytic system that cannot withstand such temperature loses its catalytic activity on regeneration and its usefulness is greatly impaired. Typical cracking catalysts have sodium levels (expressed as Na₂O) of 1% or less by weight, and preferably less than 0.5%. Indeed, refiners frequently address the sodium problem by installing “desalters” to treat feedstock before the feedstock comes in contact with the catalysts. Another avenue for addressing the problem involves removing sodium during the manufacture of the USY zeolite. Elaborate methods are therefore prescribed and followed to prevent sodium from contacting the cracking catalyst.

Metal contamination in FCC feedstocks also leads to catalyst deactivation, thereby over time reducing the performance of USY zeolite containing catalyst, and increased coking thereon. Metals typically found in FCC feedstocks, include, but are not limited to, nickel and vanadium. Refiners counteract metals contamination with metals traps, and metal passivation technology. It would therefore always be desirable for an FCC operator to utilize USY zeolite catalysts capable of performing in a metals-contaminated environment, with reduced use of separate metal contamination abatement technology.

As can be seen above, having a catalyst that addresses all these needs and problems is desirable. To date, each or all of these needs are being addressed through additives, formulation-based solutions, solutions based on specific processes of using the catalysts, etc., but none of the above described solutions suggests addressing these issues through the manufacturing process of the cracking catalyst zeolite itself, or the physical structure of the zeolite.

### BRIEF DESCRIPTION OF THE DRAWINGS

FIG. 1A is a scanning electron micrograph (SEM) of USY zeolite produced in accordance with the invention illustrating the “feathery” surface of the inventive zeolite. The zeolite illustrated in this Figure is prepared in accordance with the Examples below, and was utilized to prepare the catalyst prepared in accordance with Example 1.

FIG. 1B is a scanning electron micrograph (SEM) of USY zeolite produced in accordance with conventional calcining techniques. The zeolite illustrated was utilized to prepare catalyst in accordance with Example 2.

FIG. 1C is a scanning electron micrograph (SEM) of USY zeolite produced in a process of treating a USY zeolite under hydrothermal conditions but in water without ammonium salt.

FIG. 2A is a transmission electron micrograph (TEM) of USY zeolite produced in accordance with the invention. The zeolite illustrated in this Figure is prepared in accordance with the Examples below, and was utilized to prepare the catalyst prepared in accordance with Example 1.

FIG. 2B is a transmission electron micrograph (TEM) of USY zeolite produced in the accordance with conventional calcining techniques. The zeolite illustrated was utilized to prepare catalyst in accordance with Example 2.

FIG. 2C is a transmission electron micrograph (TEM) of USY zeolite produced in a process of treating a USY zeolite with ammonium exchange but not under hydrothermal conditions.

### SUMMARY OF THE INVENTION

It has been discovered that subjecting USY zeolite to hydrothermal treatment in an ammonium exchange bath after the USY zeolite is formed through heat treatment, e.g., calcination, results in a novel “textural” USY zeolite having “feathery” structural extensions from the zeolite's surface as viewed under SEM and/or TEM.

Briefly, the inventive process for making this novel USY zeolite comprises:
(a) heating ammonium exchanged zeolite Y to produce USY;
(b) adding the USY zeolite to an ammonium exchange bath and subjecting the USY zeolite-containing bath to hydrothermal conditions;
(c) recovering USY having a sodium content of 2% by weight or less as measured by its oxide.

The process preferably further comprises exchanging the USY produced in (a) with ammonium to reduce the sodium content of the zeolite, and preferably doing so to reduce the content to 1% by weight sodium or less, expressed as Na₂O, prior to adding the USY to hydrothermal treatment in (b). Depending on the specific conditions employed, the USY recovered from the hydrothermal treatment comprises 1% by weight or less sodium, more preferably 0.5% or less sodium, both ranges express as Na₂O.

In further preferred embodiments, the process in (b) comprises adding the USY to an ammonium exchange bath comprising 2 to 100 moles of ammonium cations per kg of USY, and subjecting the resulting exchanged bath to hydrothermal conditions comprising a temperature in the range of 100 to 200° C.

The USY zeolite produced by this process is believed to have unique surface characteristics as seen when viewing the zeolite under scanning electron microscopy (SEM) and transmission electron microscopy (TEM). The surface of the zeolite crystals has extensions that resemble feathers, which are shown by energy dispersive x-ray analysis spectroscopy (EDS) to be made up of mostly alumina compared to the interior core of the zeolite crystal. Hereinafter, the USY zeolite of the invention will be referred to as the “textural USY zeolite” because of the appearance that the feather-like extensions give the zeolite when viewed microscopically.

The textural USY zeolites of this invention can be combined with conventional FCC catalyst matrix and binder to prepare fluidizable catalyst particles to be used in FCC processes. FCC catalyst containing such zeolites are shown to be more gasoline selective than those containing USY zeolites prepared using conventional techniques. The inventive zeolites also result in less coke contamination and are shown to enhance octane in FCC product.

### DETAILED DESCRIPTION OF THE INVENTION

The first step in the inventive process is the selection of an ammonium exchanged zeolite Y. The method of preparing zeolite Y is not part of this invention, and is known in the art. See for example U.S. Pat. No. 3,293,192, the contents of which are incorporated by reference. Briefly, a silica-alumina-sodium oxide-water slurry containing a reactive particulate form of silica is equilibrated or digested at room temperature or moderate temperature for a period of at least 3 hours. At the end of this aging period, the resulting mixture is heated at an elevated temperature until the synthetic zeolite crystallizes. The synthetic zeolite Y is then separated and recovered.

The sodium zeolite Y can then be exchanged with an ammonium salt, amine salt or other salt, which on calcination decomposes and leaves an appreciable portion of the zeolite in the hydrogen form. Examples of suitable ammonium compounds of this type include ammonium chloride, ammonium sulfate, tetraethyl ammonium chloride, tetraethyl ammonium sulfate, etc. Ammonium salts, because of their ready availability and low cost, are the preferred reagents for this exchange. This exchange is carried out rapidly with an excess of salt solution. The salt may be present in an excess of about 5 to 600%, preferably about 20 to 300%.

Exchange temperatures are generally in the range of 25 to 100° C. to give satisfactory results. The exchange is generally completed in a period of about 0.1 to 24 hours. This preliminary exchange reduces the alkali metal, e.g., sodium, content of the zeolite to 5% or less, and in general, the zeolite at this stage generally contains 1.5 to 4% by weight of alkali metal. The amounts of alkali metal in the zeolite are reported herein as the oxide of the metal, e.g., Na₂O.

After exchange is completed, the ammonium exchanged zeolite Y is then usually filtered, washed and dried. It is desirable that the zeolite be washed sulfate free at this stage of the process.

The zeolite Y is then heated, e.g., calcined, at a temperature in the range of 200-800° C. to prepare USY. The heating is preferably carried out at a temperature of 480-620° C. for a period of 0.1 to 12 hours. It is believed that the heat treatment causes an internal rearrangement or transfer so that the remaining alkali metal (e.g., Na) ions are lifted from their buried sites and can now be easily ion exchanged in the next step. For the purposes of this invention, a USY zeolite is defined as a zeolite having a framework Si/Al atom ratio in the range of 3.5 to 6.0, with a corresponding unit cell size (UCS) in the range of 24.58 Å to 24.43 Å.

The USY zeolite can then optionally be treated with a solution of ammonium salt or amine salt, etc., for additional exchange to reduce the sodium level further, e.g., typically less than 1%. This exchange can be carried out for a period of 0.1 to 24 hours, conveniently for a period of 3 hours. At the end of this time the material is again filtered, washed thoroughly to remove all traces of sulfate. It is preferable that the alkali metal oxide content of the USY zeolite be no more than 1.0 weight percent.

The USY zeolite is then added to an ammonium exchange bath similar to the optional bath utilized with the sodium zeolite Y. Briefly, USY zeolite and ammonium salt is added to water such that the bath contains 2 to 100 moles of ammonium cation per kilogram (kg) of USY zeolite in 10 kg of water. The bath is then subjected to hydrothermal conditions. Generally, the temperature is in the range of 100 to 200° C., the pressure in the range of 1 to 16 atmospheres, and the bath has a pH in the range of 5 to 7. The USY zeolite is typically subjected to these conditions for a time of 0.1 to 3 hours.

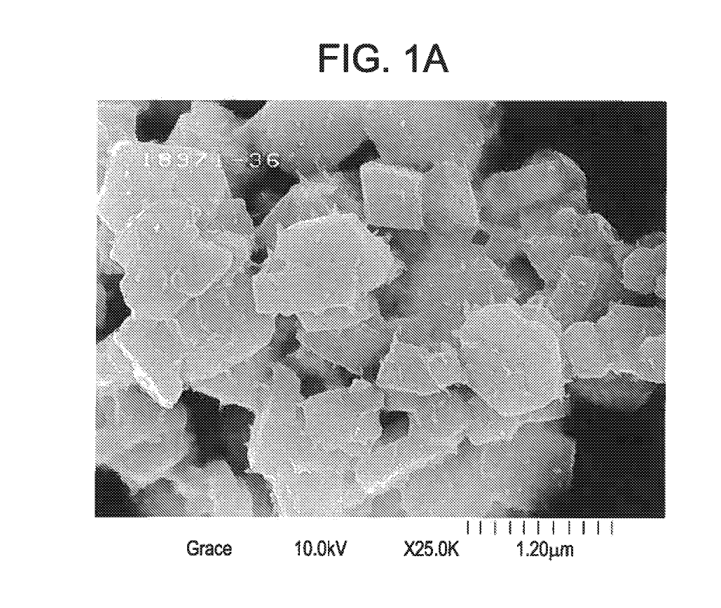

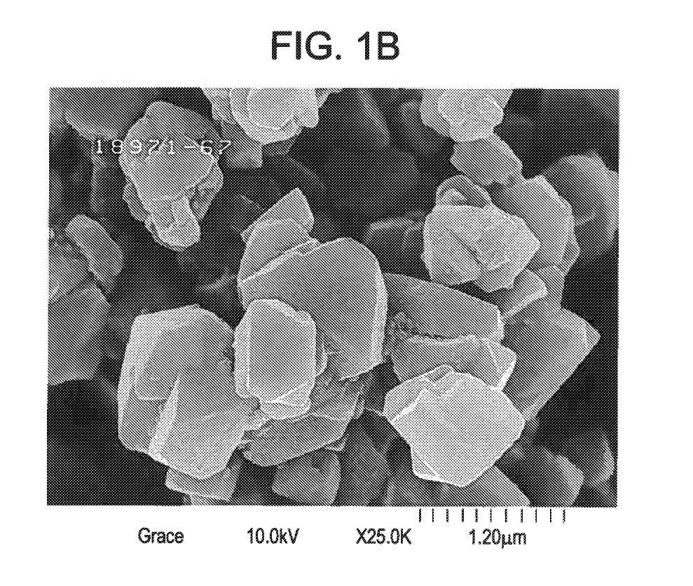

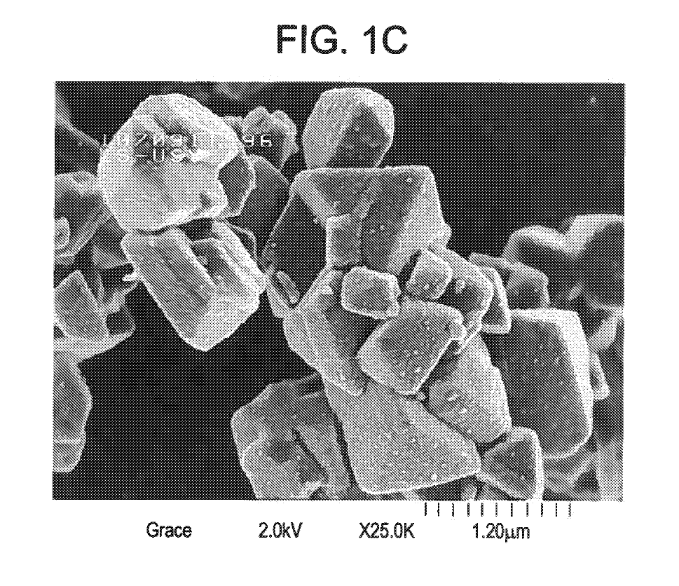

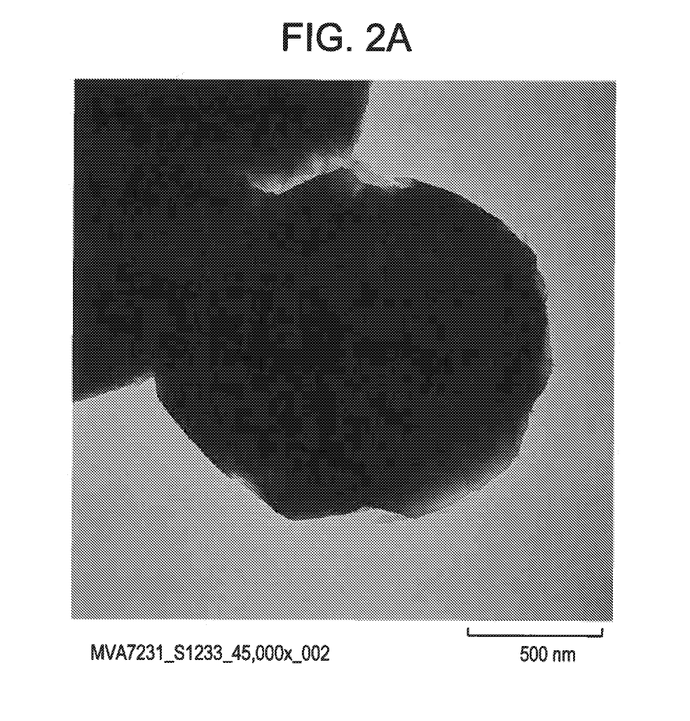

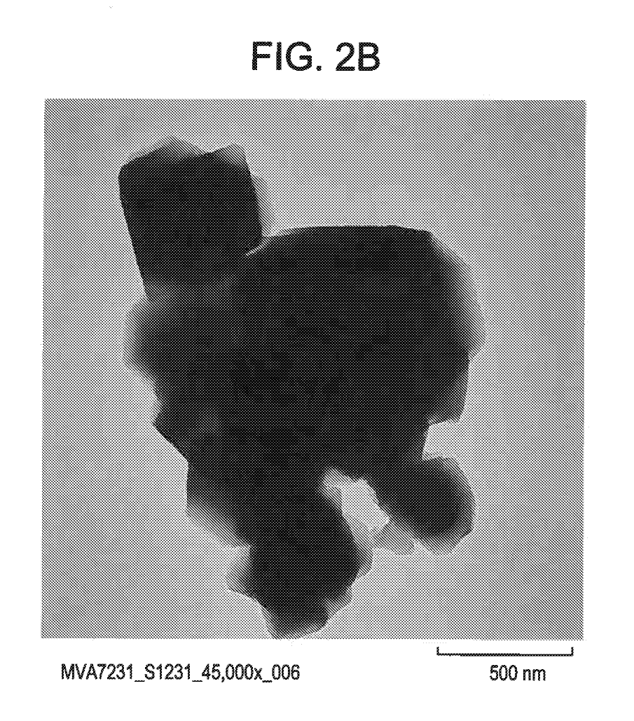

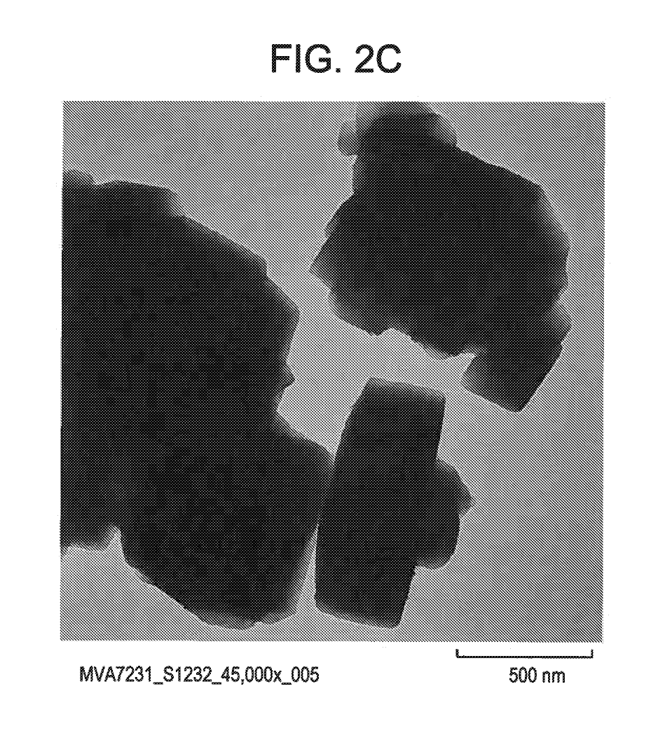

The textural USY zeolite recovered from the hydrothermal treatment is believed to be unique. FIGS. 1A and 2A are micrographs showing inorganic oxide structural elements extending from the surface of the inventive USY zeolite's primary crystal structure. The structural elements or extensions in the micrographs appear “feathery”, thereby giving the invention its textural appearance. Both x-ray photoelectron spectroscopy (XPS) and electron dispersive spectroscopy (EDS) analysis indicate that the structural elements have alumina to silica molar ratios greater than those ratios measured for the primary crystal structure. Typically, the alumina to silica molar ratio as measured by EDS is greater than one for the structural elements. See Example 9 and Table 4. Without being held to particular theory, it is believed that heating the zeolite Y dealuminates the zeolite Y's silica alumina structure, thereby causing alumina to migrate to the surface of the crystal structure of the resulting USY zeolite. The subsequent hydrothermal conditions redeposits the alumina on the crystal's surface to form the extensions described above and illustrated in the figures, thereby maximizing availability of active Lewis acid sites that are responsible for the zeolite's performance when the zeolite is incorporated into a cracking catalyst. The Lewis acid sites are believed to initiate cracking of parafins.

The sodium level of the textural USY zeolite recovered from the hydrothermal treatment is relatively low, and preferably is 2% or less, preferably 1% or less, and especially desirable to be 0.5% or less by weight, as measured by Na₂O.

### Fluidizable Catalyst Components

The USY zeolite of this invention can be combined with conventional materials to make a form capable of being maintained in a fluidized state within a FCCU operated under conventional conditions, e.g., manufactured to be a fine porous powdery material composed of the oxides of silicon and aluminum. Generally speaking, the invention would typically be incorporated into matrix and/or binder and then particulated. When the particulate is aerated with gas, the particulated catalytic material attains a fluid-like state that allows it to behave like a liquid. This property permits the catalyst to have enhanced contact with the hydrocarbon feedstock feed to the FCCU and to be circulated between the reactor and the other units of the overall process (e.g., regenerator). Hence, the term “fluid” has been adopted by the industry to describe this material. Fluidizable catalyst particles generally have a size in the range of 20-200 microns, and have an average particle size of 60-100 microns.

Inorganic oxides used to make the catalyst form within the catalyst particles what is typically referred to as “matrix”. Matrix frequently has activity with respect to modifying the product of the FCC process, and in particular, improved conversion of high boiling feedstock molecules. Inorganic oxides suitable as matrix include, but are not limited to, non-zeolitic inorganic oxides, such as silica, alumina, silica-alumina, magnesia, boria, titania, zirconia and mixtures thereof. The matrices may include one or more of various known clays, such as montmorillonite, kaolin, halloysite, bentonite, attapulgite, and the like. See U.S. Pat. No. 3,867,308; U.S. Pat. No. 3,957,689 and U.S. Pat. No. 4,458,023. Other suitable clays include those that are leached by acid or base to increase the clay's surface area, e.g., increasing the clay's surface area to about 50 to about 350 m²/g as measured by BET. The matrix component may be present in the catalyst in amounts ranging from 0 to about 60 weight percent. In certain embodiments, alumina is used and can comprise from about 10 to about 50 weight percent of the total catalyst composition.

It is preferable to select a matrix forming material that provides a surface area (as measured by BET) of at least about 25 m²/g, preferably 45 to 130 m²/g. Higher surface area matrix enhances cracking of high boiling feedstock molecules. The total surface area of the catalyst composition is generally at least about 150 m²/g, either fresh or as treated at 1500° F. for four hours with 100% steam.

Manufacturing methods known to those skilled in the art can be used to make the fluidizable particulate. The processes generally comprise slurrying, milling, spray drying, calcining, and recovering the particles. See U.S. Pat. No. 3,444,097, as well as WO 98/41595 and U.S. Pat. No. 5,366,948. For example, a slurry of the textural USY zeolite may be formed by deagglomerating the zeolite, preferably in an aqueous solution. A slurry of matrix may be formed by mixing the desired optional components mentioned above such as clay and/or other inorganic oxides in an aqueous solution. The zeolite slurry and any slurry of optional components, e.g., matrix, are then mixed thoroughly and spray dried to form catalyst particles, for example, having an average particle size of less than 200 microns in diameter, preferably in the ranges mentioned above. The textural USY zeolite component may also include phosphorous or a phosphorous compound for any of the functions generally attributed thereto, for example, stability of the Y-type zeolite. The phosphorous can be incorporated with the Y-type zeolite as described in U.S. Pat. No. 5,378,670, the contents of which are incorporated by reference.

The textural USY zeolite can comprise at least about 10% by weight of the composition, and typically 10 to 60% by weight. The remaining portion of the catalyst, e.g., 90% or less, comprises preferred optional components such as phosphorous, matrix, and rare earth, as well as other optional components such as binder, metals traps, and other types of components typically found in products used in FCC processes. These optional components can be alumina sol, silica sol, and peptized alumina binders for the Y-type zeolite. Alumina sol binders, and preferably alumina hydrosol binders, are particularly suitable.

It may be preferable to add rare earth to catalyst formulations comprising the textural USY zeolite of this invention. The addition of rare earth enhances the catalyst's performance in the FCC unit. Suitable rare earth includes lanthanum, cerium, praseodymium, and mixtures thereof, which can be added in the form of a salt into a mixture containing the zeolite and other formulation components prior to being spray dried. Suitable salts include rare earth nitrates, carbonates, and/or chlorides. Rare earth can also be added to the zeolite per se through separate exchanges with any of the aforementioned salts. Alternatively, rare earth can be impregnated into a finished catalyst particulate containing the textural USY zeolite.

The catalyst particles comprising the invention can be used in FCC processes in the same fashion as conventional USY or REUSY zeolite containing catalysts.

Typical FCC processes entail cracking a hydrocarbon feedstock in a cracking reactor or reactor stage in the presence of fluid cracking catalyst particles to produce liquid and gaseous product streams. The product streams are removed and the catalyst particles are subsequently passed to a regenerator stage where the particles are regenerated by exposure to an oxidizing atmosphere to remove coke contaminant. The regenerated particles are then circulated back to the cracking zone to catalyze further hydrocarbon cracking. In this manner, an inventory of catalyst particles is circulated between the cracking stage and the regenerator stage during the overall cracking process.

The catalyst particles may be added directly to the cracking stage, to the regeneration stage of the cracking apparatus or at any other suitable point. The catalyst particles may be added to the circulating catalyst particle inventory while the cracking process is underway or they may be present in the inventory at the start-up of the FCC operation.

As an example, the compositions of this invention can be added to a FCCU when replacing existing equilibrium catalyst inventory with fresh catalyst. The replacement of equilibrium zeolite catalyst by fresh catalyst is normally done on a cost versus activity basis. The refiner usually balances the cost of introducing new catalyst to the inventory with respect to the production of desired hydrocarbon product fractions. Under FCCU reactor conditions carbocation reactions occur to cause molecular size reduction of petroleum hydrocarbons feedstock introduced into the reactor. As fresh catalyst equilibrates within an FCCU, it is exposed to various conditions, such as the deposition of feedstock contaminants produced during that reaction and severe regeneration operating conditions. Thus, equilibrium catalysts may contain high levels of metal contaminants, exhibit somewhat lower activity, have lower aluminum atom content in the zeolite framework and have different physical properties than fresh catalyst. In normal operation, refiners withdraw small amount of the equilibrium catalyst from the regenerators and replace it with fresh catalyst to control the quality (e.g., its activity and metal content) of the circulating catalyst inventory.

The FCC process is conducted at temperatures ranging from about 400° to 700° C. with regeneration occurring at temperatures of from about 500° to 850° C. The particular conditions will depend on the petroleum feedstock being treated, the product streams desired and other conditions well known to refiners. The FCC catalyst (i.e., inventory) is circulated through the unit in a continuous manner between catalytic cracking reaction and regeneration while maintaining the equilibrium catalyst in the reactor.

A variety of hydrocarbon feedstocks can be cracked in the FCC unit to produce gasoline, and other petroleum products. Typical feedstocks include in whole or in part, a gas oil (e.g., light, medium, or heavy gas oil) having an initial boiling point above about 120° C. [250° F.], a 50% point of at least about 315° C. [600° F.], and an end point up to about 850° C. [1562° F.]. The feedstock may also include deep cut gas oil, vacuum gas oil, coker gas oil, thermal oil, residual oil, cycle stock, whole top crude, tar sand oil, shale oil, synthetic fuel, heavy hydrocarbon fractions derived from the destructive hydrogenation of coal, tar, pitches, asphalts, hydrotreated feedstocks derived from any of the foregoing, and the like. As will be recognized, the distillation of higher boiling petroleum fractions above about 400° C. must be carried out under vacuum in order to avoid thermal cracking. The boiling temperatures utilized herein are expressed in terms of convenience of the boiling point corrected to atmospheric pressure. High metal content resids or deeper cut gas oils having an end point of up to about 850° C. can be cracked, and the invention is particularly suitable for those feeds having metals contamination.

The examples below illustrate the benefits of using the inventive USY in FCC catalysts. These catalysts show increased gasoline yield, lower coke yields, and increased gasoline olefin yields in the products of an FCC unit compared to catalysts comprising conventional USY zeolite.

To further illustrate the present invention and the advantages thereof, the following specific examples are given. The examples are given for illustrative purposes only and are not meant to be a limitation on the claims appended hereto. It should be understood that the invention is not limited to the specific details set forth in the examples.

All parts and percentages in the examples, as well as the remainder of the specification, which refers to solid compositions or concentrations, are by weight unless otherwise specified. However, all parts and percentages in the examples as well as the remainder of the specification referring to gas compositions are molar or by volume unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited.

### EXAMPLES

### Inventive Textural USY Zeolite Manufacture

The textural USY zeolite of this invention was manufactured according to the procedure below. A slurry of 100 g low sodium USY (dry base, 0.9 weight % by weight Na₂O), 130 g ammonium sulfate (A/S) solution and 1000 g deionized water (1:1.3:10) was formed, and the pH of the slurry was adjusted to 5 with 0.1 g 20 wt % H₂SO₄. This slurry was added into an autoclave reactor, heated up to 177° C. and treated for 5 minutes. The slurry from the reactor was then cooled down to room temperature, followed by filtration and washed three times with 300 g portions of 90° C. hot DI water. The resulting USY zeolite had a unit cell size of 24.54.

### USY Zeolite Subject to Exchange (No Hydrothermal Treatment)

A slurry of 25 g low sodium USY (dry base, 0.9 wt % Na2O), 25 g ammonium sulfate (A/S) solution and 125 g deionized (DI) water (at a weight ratio of 1:1:5, respectively) was formed. This slurry was heated up to 95° C. and treated for 60 minutes. The slurry from the reactor was then cooled down to room temperature, followed by filtration and washed three times with 75 g portions of 90° C. hot DI water.

### USY Zeolite Subject to Hydrothermal Conditions (No Exchange)

348.4 grams of USY zeolite slurry (100 g DB) was diluted with 651.6 g deionized water. The slurry was autoclaved with stirring for one minute at 177° C. After cooling, the slurry was filtered and oven-dried at 120° C. (about 250° F.). The slurry from the reactor was then cooled down to room temperature, followed by filtration and washed three times with 300 g portions of 90° C. hot deionized (DI) water. The resulting USY zeolite had a unit cell size of 24.57 Å and surface area of 820 m²/g.

### Example 1 (Invention)

A catalyst (designated Catalyst 1) was prepared using the textural USY prepared above. 38% of the textural USY (0.2% Na₂O or less), 16% alumina binder from aluminum chlorhydrol, 10% alumina from boehmite alumina phase, 2% rare earth oxide (RE₂O₃ from RECl₃ solution), and clay were slurry mixed followed by spray drying and calcining for 1 hour at 1100° F.

### Example 2 (Comparison)

A catalyst (designated Catalyst 2) was prepared from a low sodium USY zeolite prepared using conventional techniques (Conventional USY). 38% Conventional USY, 16% alumina binder from aluminum chlorhydrol, 10% alumina from boehmite alumina, 2% rare earth oxide (RE₂O₃ from RECl₃ solution), and clay were slurry mixed followed by spray drying and calcining 1 hour at 1100° F.

### Example 3 (Invention)

A catalyst (designated Catalyst 3) was prepared using the textural USY zeolite as described above. 39% of the textural USY, 16% alumina binder from aluminum chlorhydrol, 10% alumina from boehmite alumina phase, 5.9% rare earth oxide (RE₂O₃ from RE₂(CO₃)₃ solution), and clay were slurry mixed followed by spray drying and calcining 1 hour at 1100° F.

### Example 4 (Comparison)

A catalyst (designated as Catalyst 4) was prepared from a low sodium USY zeolite prepared using conventional techniques (Conventional USY). 39% Conventional USY, 16% alumina binder from aluminum chlorhydrol, 10% alumina from boehmite alumina, 5.9% rare earth oxide (RE₂O₃ from RE₂(CO₃)₃ solution), and clay were slurry mixed followed by spray drying and calcining 1 hour at 1100° F.

### Example 5

All of the catalysts described in Examples 1-4 above were steam deactivated in the presence of metals. Two different protocals were performed for later testing.

For catalysts 1 and 2, in the presence of 1000 ppm Ni/2000 ppm V; for catalysts 3 and 4, in the presence of 2000 ppm Ni/3000 ppm V. CPS is a cyclic propylene steaming procedure where the catalysts are impregnated (to incipient wetness) with V and Ni compounds prior to deactivation in reduction (by propylene) alternating with oxidation cycles or cyclic impregnation (CMI) or cyclic deposition (CDU) of metals on a catalyst in a fixed fluid bed reactor through repeated cycles of reaction stripping and regeneration. The deactivation of these catalysts is carried out at 1465° F. for 30 cycles. Each cycle includes: 30 minutes on propylene, 2 minutes on N₂, 6 minutes on SO₂ and 2 minutes on N₂. The reactor is a fixed fluid bed, and the metals are deposited in the catalyst during the cycles using V and Ni organo-complexes spiked in a VGO feed. At the start of the 30^{th} cycle the controller is on propylene. At the end of the propylene segment, the steam and gasses are turned off, and reactors are cooled under N₂.

The physical and chemical properties of the four catalysts before and after the CPS deactivation are listed in Table 1. It is seen that the inventive catalysts 1 and 3 had lower sodium relative to the catalysts 2 and 4 containing conventional USY zeolite.

Unless noted otherwise, surface areas referred to herein were measured using BET methods, average particle size (APS) was measured using Malvern light scattering particle size analyzers, and average bulk density (ABD) expressed as mass/volume of loose (uncompacted) powder.

Unit cell size is measured using XRD via comparison with silicon reference material and method based on ASTM D-3942.

The unit cell size is then readily measured from the XRD patterns using commercially available software, or by manual calculation from XRD peaks observed at the angles and formula below:

| E-Cat (Low Angle) | 2° Theta |
|---|---|
| Sample | 23.50 |
| Silicon | 28.467 |

$Unit Cell = d ( hkl ) * \sqrt{{h}^{2} + {k}^{2} + {l}^{2}} , wherein$ $d ( hkl ) = \frac{λ}{2 sin θ}$ $d ( hkl ) = d spacing of zeolite peak of interest$ $\begin{matrix}λ = X \text{-} ray wavelength \\ = 1.54178 for low angle ( Cu X \text{-} ray tube ) \\ = 1.54060 for high angle ( Cu X \text{-} ray tube )\end{matrix}$

TABLE 1

| | | | | Example |
|---|---|---|---|---|
| | | Example 2² | | 4⁴ |
| | Example 1¹ | (Com- | Example 3³ | (Com- |
| Properties | (Invention) | parison) | (Invention) | parison) |
| Physical Analysis | | | | |
| ABD @ 1000 | 0.76 | 0.71 | 0.76 | 0.72 |
| (g/cc) | | | | |
| Pore Volume | 0.37 | 0.38 | 0.38 | 0.40 |
| (cc/g) | | | | |
| APS (microns) | 65 | 79 | 59 | 75 |
| Surface Area | 318 | 317 | 311 | 319 |
| (m²/g) | | | | |
| Zeolite Surface | 260 | 266 | 259 | 271 |
| Area (m²/g | | | | |
| Matrix Surface | 58 | 51 | 51 | 48 |
| Area (m²/g) | | | | |
| Unit Cell Size | 24.54 | 24.52 | 24.55 | 24.51 |
| Steamed Analysis | | | | |
| Surface Area | 188 | 181 | 311 | 319 |
| (m²/g) | | | | |
| Zeolite Surface | 147 | 142 | 145 | 144 |
| Area (m²/g) | | | | |
| Matrix Surface | 41 | 39 | 35 | 35 |
| Area (m²/g) | | | | |
| Unit Cell Size | 24.28 | 24.25 | 24.28 | 24.25 |

¹2000 ppm V/1000 ppm Ni CPS-1465 F.
²2000 ppm V/1000 ppm Ni CPS-1465 F.
³3000 ppm V/2000 ppm Ni CPS-3 1465 F.
⁴3000 ppm V/2000 ppm Ni CPS-3 1465 F.

### Example 6

Each of the four deactivated catalysts were tested in an Advanced Cracking Evaluation (ACE) unit. Briefly, the ACE is a fixed fluid bed reactor. There are three heating zones in the reactor, with the top one as the preheater. The temperature of the catalytic bed was measured by a thermocouple placed inside the reactor and was kept constant. The feedstock was fed into a preheater and then to the reactor located with a catalyst by a syringe-metering pump. Catalyst-to-oil ratio was varied by changing the mass of catalyst while the total amount of feed was kept constant at 1.5 g. The tests were carried out under the conditions typical for FCC units: cracking temperature 980° F., catalyst to oil mass ratios of 4, 6, and 8, and contact time of thirty (30) seconds. The distribution of gaseous products was analyzed by gas chromatograph. The boiling point range of the liquid products was determined by simulated distillation gas chromatograph.

The products from ACE unit is typically classified as follows:
1. Gases, which include C₁-C₄;
2. Gasoline range, boiling point (bp) 30-200° C. which include C₅-C₁₂;
3. Light cycle oil (LCO), by 200-350° C. which include C₁₂-C₂₂;
4. Heavy cycle oil (HCO, bottoms), by above 350° C.

The results from the ACE testing are shown in Table 2 and are summarized as follows.

The ACE results demonstrate that the inventive USY zeolite-containing FCC catalysts 1 and 3 are more active and produce less coke, more gasoline olefins, and higher octane, when compared to the conventional USY zeolite-containing FCC catalysts 2 and 4.

The interpolated yields are based on conversions of 73% for catalysts 1 and 2, and 75% for catalysts 3 and 4. The results are as follows:

(1) Gasoline yields increased by 0.3% for the catalyst 1, 1.96% for the catalyst 3.
(2) LCO yields increased by 0.83% for the catalyst 1, 1.68% for the catalyst 3.
(3) Bottoms yields decreased by 0.83% for the catalyst 1, 1.68% for the catalyst 3.
(4) Coke yields decreased by 0.26% for the catalyst 1, 1.25% for the catalyst 3.
(5) Gasoline olefins increased by 2.42% for the catalysts 1, 4.14% for the catalyst 3.
(6) Research octane number (RON) increased by 0.52 for the catalyst 1, 0.23 for the catalyst 3.

TABLE 2

| | Example 1 | Example 2 | Example 3 | Example 4 |
|---|---|---|---|---|
| Conversion | 73 | 73 | 75 | 75 |
| Catalyst to Oil Ratio | 5.94 | 6.35 | 7.45 | 7.02 |
| Hydrogen | 0.18 | 0.15 | 0.38 | 0.41 |
| Methane | 0.67 | 0.68 | 0.76 | 0.79 |
| Ethylene | 0.58 | 0.59 | 0.65 | 0.75 |
| Tot C1 + C2 | 1.67 | 1.70 | 1.86 | 2.00 |
| Dry Gas | 1.86 | 1.85 | 2.23 | 2.41 |
| Propylene | 4.95 | 4.87 | 5.19 | 5.11 |
| Propane | 0.82 | 0.91 | 0.85 | 1.11 |
| Total C3's | 5.77 | 5.78 | 6.04 | 6.22 |
| 1-Butene | 1.52 | 1.46 | 1.55 | 1.44 |
| Isobutylene | 1.94 | 1.71 | 2.00 | 1.63 |
| Trans-2-butene | 1.79 | 1.72 | 1.86 | 1.70 |
| Cis-2-butene | 1.45 | 1.39 | 1.51 | 1.38 |
| Total C4=s | 6.69 | 6.28 | 6.93 | 6.14 |
| 1,3-Butadiene | 0.02 | 0.02 | 0.02 | 0.02 |
| IsoButane | 3.96 | 4.29 | 4.06 | 4.95 |
| n-C4 | 0.82 | 0.92 | 0.83 | 1.08 |
| Total C4s | 11.46 | 11.49 | 11.82 | 12.16 |
| LPG Wt % | 17.23 | 17.27 | 17.86 | 18.39 |
| Wet Gas | 19.08 | 19.12 | 20.09 | 20.80 |
| Gasoline | 50.76 | 50.46 | 50.66 | 48.70 |
| LCO | 20.50 | 19.67 | 19.62 | 17.94 |
| Bottoms | 6.50 | 7.33 | 5.38 | 7.06 |
| Coke | 3.16 | 3.42 | 4.25 | 5.50 |
| Paraffins | 33.79 | 35.87 | 33.25 | 36.50 |
| IsoParaffins | 30.28 | 32.29 | 29.91 | 32.94 |
| Olefins | 23.96 | 21.54 | 23.37 | 19.23 |
| Naphthenes | 10.34 | 10.47 | 9.38 | 8.70 |
| Aromatics | 31.91 | 32.11 | 34.01 | 35.57 |
| RON | 91.58 | 91.06 | 92.38 | 92.15 |
| MON | 80.16 | 80.18 | 80.79 | 81.31 |

### Example 7

The textural USY zeolite prepared in accordance with the invention was scanned and compared to scans of two other USY zeolites. One of the two additional zeolites was one that is typically used in commercial formulations, wherein the zeolite was prepared using conventional manufacturing. The third zeolite (which is not textural) was prepared in accordance with the method of the invention except the aqueous mixture containing USY zeolite did not contain ammonium salt. The surface structures of each USY were studied by Scanning Electron Microscopy (SEM) and their images are shown in FIGS. 1A, 1B, and 1C. It is indicative that subjecting USY to hydrothermal treatment in the presence of an ammonium exchange bath plays a synergistic role in the formation of the textural zeolite structure.

### Example 8

The surface composition of the three USY zeolites were measured by X-ray Photoelectron Spectroscopy (XPS) and their results are listed in Table 1. It is indicated that there is more alumina on the surface of the autoclaved feathery USY than both conventional USY and ion exchanged USY without hydrothermal treatment, e.g., in an autoclave.

TABLE 3

| | | |
|---|---|---|
| Conventional | A/S exchange, no | |
| USY | autoclave | Inventive USY Zeolite |

Atomic Concentration (%)

| | | | |
|---|---|---|---|
| O | 65.4 | 68.8 | 69.5 |
| C | 7.1 | 4.0 | 1.2 |
| Al | 11.9 | 13.9 | 16.2 |
| Si | 15.5 | 13.3 | 13.1 |
| Al/Si | 0.77 | 1.05 | 1.24 |

### Example 9

The zeolites described prior to Example 1 were analyzed using electron X-ray dispersive spectroscopy (EDS). An Oxford Instruments INCA Microanalysis Suite Version 4.07 was used to calculate semi-quantitative weight and atomic percents from the EDS spectra. EDS spectra and semi-quantitative elemental composition data were collected from the drop mount and cross-sectioned prepared samples at the center of an individual crystal and its edge, respectively. Spectrum processing is as follows: Peaks possibly omitted: 0.270, 0.932, 8.037, 8.902 keV. Quantization method is Cliff Lorimer think ratio section. The cliff-Lorimer ratio technique for thin film X-ray micro-analysis requires knowledge of the k factors which relate the measured X-ray intensities to the composition of the specimen. See Table 4 below, which tabulates the data obtained from the EDS analysis⁵. ⁵ Energy dispersive X-ray spectroscopy (EDS) is an analytical technique used for the elemental analysis or chemical characterization of a sample. As a type of spectroscopy, it relies on the investigation of a sample through interactions between electromagnetic radiation and matter, analyzing x-rays emitted by the matter in response to being hit with charged particles. Its characterization capabilities are due in large part to the fundamental principle that each element has a unique atomic structure allowing x-rays that are characteristic of an element's atomic structure to be identified uniquely from each other.

TABLE 4

| Conventional | | A/S exchanged Zeolite, | | Inventive | |
|---|---|---|---|---|---|
| USY | | no autoclave | | USY Zeolite | |
| Center | Edge | Center | Edge | Center | Edge |

Zeolite crystal
Atomic Concentration (%)

| | | | | | | |
|---|---|---|---|---|---|---|
| Al | 12.8 | 7.7 | 10.0 | 9.1 | 9.4 | 23.4 |
| Si | 39.6 | 28.9 | 27.5 | 23.6 | 28.7 | 9.9 |
| Al/Si | 0.32 | 0.27 | 0.36 | 0.39 | 0.33 | 2.36 |

Cross-section of Zeolite Crystal
Atomic Concentration (%)

| | | | | | | |
|---|---|---|---|---|---|---|
| Al | 8.3 | 6.7 | 9.0 | 8.6 | 5.6 | 12.4 |
| Si | 23.2 | 17.6 | 28.9 | 25.8 | 21 | 0.6 |
| Al/Si | 0.36 | 0.38 | 0.31 | 0.33 | 0.27 | 20.67 |

Spectrum processing: Peak possibly omitted: 0.268, 8.032. 8.900 keV
Quantitation method: Cliff Lorimer thin ratio section.
Processing option: All elements analyzed, Number of iterations = 1 Standardless

What is claimed is:

1. A process for making ultrastable zeolite Y (USY) comprising:
(a) heating ammonium exchanged zeolite Y to produce USY zeolite;
(b) adding the USY zeolite to an ammonium exchange bath and subjecting the USY zeolite-containing bath to hydrothermal conditions; and
(c) recovering USY zeolite having a sodium content of 2% or less as measured by Na₂O.

2. A process according to claim 1 wherein the USY produced in (a) comprises sodium as Na₂O in amount of 5% or less by weight of the USY zeolite.

3. A process according to claim 1 wherein the process further comprises exchanging the USY produced in (a) with ammonium salt prior to subjecting the USY to the hydrothermal conditions in accordance with (b).

4. A process according to claim 1 wherein the USY zeolite recovered from (c) comprises sodium as Na₂O in amount of 1% by weight or less of the USY zeolite Y.

5. A process according to claim 1 wherein the USY zeolite recovered from (c) comprises sodium as Na₂O in amount of 0.5% by weight or less of the USY zeolite.

6. A process according to claim 1 wherein the ammonium exchange bath in (b) comprises ammonium sulfate.

7. A process according to claim 1 wherein the ammonium exchange bath in (b) comprises ammonium salt in a concentration such that the bath comprises 2 to 100 moles of ammonium cations per kilogram of USY zeolite.

8. A process according to claim 6, wherein the ammonium sulfate is in a concentration such that the exchange bath in (b) comprises 2 to 100 moles of ammonium cations per kilogram of USY zeolite.

9. A process according to claim 1 wherein the USY zeolite added in (b) is subjected to a temperature in the range of 100 to 200° C.

10. A process according to claim 7 wherein the USY zeolite added in (b) is subjected to a temperature in the range of 100 to 200° C.

11. A USY zeolite, wherein the zeolite surface has one or more structural elements extending from the surface of the zeolite and the structural element possesses a molar alumina to silica ratio that is greater than the molar alumina to silica ratio of the zeolite structure from the structural element extends.

12. A USY zeolite of claim 11 wherein the molar alumina to silica ratio of the structural element is greater than one.

13. A USY zeolite of claim 11 having one or more structural elements substantially similar to that shown in the SEM of FIG. 1A.

14. A USY zeolite of claim 13, wherein the zeolite is prepared according to the process recited in claim 1.

15. A process for manufacturing cracking catalyst, comprising:
(a) heating ammonium exchanged zeolite Y to produce USY zeolite;
(b) adding the USY zeolite to an ammonium exchange bath and subjecting the USY zeolite-containing bath to hydrothermal conditions;
(c) recovering USY zeolite having a sodium content of 2% by weight or less as measured by Na₂O;
(d) adding the USY recovered in (c) to inorganic oxide suitable for binding the USY in particulate form, and
(e) forming fluidizable particulate from the USY zeolite and inorganic oxide in (d).

16. A process according to claim 15 wherein the ammonium exchange bath in (b) comprises ammonium salt in a concentration such that the exchange bath comprises 2 to 100 moles of ammonium cations per kilogram of USY zeolite.

17. A process according to claim 15 wherein the USY zeolite added in (b) is subjected to a temperature in the range of 100 to 200° C.

18. A process according to claim 17 wherein the ammonium exchange bath in (b) comprises ammonium salt in a concentration such that the exchange bath comprises 2 to 100 moles of ammonium cations per kilogram of USY zeolite.

19. A process according to claim 15, wherein the inorganic oxide is selected from the group consisting of silica, alumina, silica-alumina, magnesia, boria, zirconia and mixtures thereof.

20. A process according to claim 15, wherein the USY and the inorganic oxide in (d) are in aqueous slurry.

21. A process according to claim 15, wherein the USY and inorganic oxide in (e) is formed into particulates having an average particle size in the range of 20 to 200 microns.

22. A process according to claim 15 further comprising adding rare earth to a formulation comprising the USY prior to forming the particulate.

23. A cracking catalyst produced according to the process of claim 15.

24. A cracking catalyst according to claim 23, further comprising rare earth.

25. A cracking catalyst according to claim 24, wherein the rare earth is selected from the group consisting of lanthanum, cerium, praseodymium, and mixtures of two or more of the same.

26. A cracking catalyst according to claim 24, comprising 0.5 to 10% by weight rare earth, as measured by its oxide.
